(19) United States
(12) Patent Application Publication
(10) Pub. No.: US 2026/0201856 A1
(43) Pub. Date: Jul. 16, 2026

(54) GAS VALVE

(71) Applicant: Robert Bosch GmbH, Stuttgart (DE)

(72) Inventors: Heinrich Werger, Kuchl (AT); Markus Korn, Anif (AT)

(21) Appl. No.: 19/135,265

(22) PCT Filed: Nov. 27, 2023
(86) PCT No.: PCT/EP2023/083100

§ 371 Date: Jun. 3, 2025

(30) Foreign Application Priority Data
Dec. 5, 2022 (DE) 10 2022 213 080.4

(51) Int. Cl. F02M 21/02

(52) U.S. Cl. CPC F02M 21/0281; F02M 21/026

(57) ABSTRACT

Gas valve for metered dispensing of a gaseous fuel, having a valve body (1) in which a gas space (2) which can be filled with a gaseous fuel is formed, with a valve element (3) arranged so as to be movable longitudinally therein. The valve element (3) comprises a plate-shaped end portion (6), which cooperates with a valve seat (7) formed on the valve body (1) for opening and closing an annular flow area (9). A cylindrical sleeve (10) surrounding the valve body (1) comprises a base portion (11) forming the end of the sleeve (10) and a lateral surface (12) adjoining the base portion (11), wherein the base portion (11), the sleeve (12), and the plate-shaped end portion (6) delimit a chamber (15). The chamber (15) comprises a blow-in opening (16), which is formed in the base portion (11) and in the lateral surface (12) of the cylindrical sleeve (10).

### BACKGROUND

The invention relates to a gas valve as used for metered dispensing of a gaseous fuel into a combustion chamber or into the intake tract of an engine.

When operating internal combustion engines with gaseous fuels, the fuel is metered under a blown-in pressure into the intake tract or also directly into a combustion chamber of the engine. To this end, a gas valve with a longitudinally movable valve element that is moved against the force of a closing spring by way of an electrical actuator and that cooperates with a valve seat is usually used. Due to the longitudinal movement, an annular flow area is released or resealed after deactivation of the actuator. The valve element thereby opens outwardly, that is to say, the opening movement of the valve element occurs out of the gas valve. The electrical actuator is usually an electromagnet that cooperates with a magnetic armature or plunge armature, thus exerting an opening force on the valve element. Instead of this so-called direct control, in which the magnetic force acts directly on the magnetic armature fixedly connected to the valve element, the control of the valve element can also be carried out indirectly via a servo-hydraulic mechanism. In this case, piezoelectric actuators can also be used, for example, because a small stroke of the actuator is sufficient here.

Accurate dosing and exact timing is important, especially in the case of fuel blown-in directly into a combustion chamber, in order to achieve effective and low-pollutant combustion. In addition, in order to optimize combustion, the distribution of the gaseous fuel in the combustion chamber is important, so that a good mixing with the air takes place in the combustion chamber and no areas are created in which there is a high fuel or excess air. For this purpose, for example, it is known from DE 10 2021 201 085 A1 to provide a chamber downstream of the valve seat in the gas valve, from which the fuel passes outwardly through a blow-in opening. The blow-in opening can be configured as an oblique passage in relation to the longitudinal axis of the gas valve so as to deflect the gas jet into the desired direction.

As the gas valve with its end projects into the combustion chamber, the length and thus the construction space is limited. In order to achieve a sufficient steering effect through the inclined blow-in opening, it must on the one hand be as long as possible and thus have a large length-to-diameter ratio (L/D). On the other hand, a large diameter is required in order to be able to deliver the required gas quantity in a short time at the right time. A blow-in opening with both a large L/D ratio and a large diameter accordingly requires a lot of design space, but is usually not available. This means that only a low steering effect of the gas jet can be achieved via an inclined blow-in opening, which makes the optimal distribution of the gaseous fuel in the combustion chamber more difficult.

### SUMMARY

The gas valve according to the invention has the advantage that, with a low design space, an effective steering of the leaking gas jet is enabled in order to optimally distribute the gaseous fuel in the combustion chamber. For this purpose, the gas valve has a valve body in which a gas space which can be filled with a gaseous fuel is formed, with a valve element arranged so as to be movable longitudinally therein. The valve element comprises a plate-shaped end portion, which cooperates with a valve seat formed on the valve body for opening and closing an annular flow area. A cylindrical sleeve surrounds the valve body and comprises a base portion forming the end of the sleeve and a lateral surface adjoining the base portion, wherein the base portion, the sleeve, and the plate-shaped end portion delimit a chamber. The sleeve has a blow-in opening through which the gaseous fuel exits the chamber, wherein the blow-in opening is formed in the base portion and the lateral surface.

Upon release of the flow area, the fuel flows from the gas space of the gas valve and from there through the blow-in opening into the combustion chamber of the engine. The formation of the blow-in opening in the lateral surface of the sleeve forms a lateral opening in relation to the longitudinal axis of the valve body, which deflects the gas jet effectively laterally, even at a small L/D ratio of the blow-in opening, wherein the sleeve only requires a small wall thickness and thus little design space. The gas jet thus also reaches the edge areas of the combustion chamber and optimally mixes with the air in the combustion chamber, which ensures effective and low-pollutant combustion.

In a first advantageous embodiment of the invention, the blow-in opening is formed by a bore formed in the base portion of the cylindrical sleeve and a lateral opening in its lateral surface, which together form the blow-in opening. This allows for a targeted design of the lateral opening and thus a simple optimization of the lateral deflection of the gas jet through this opening.

In a further advantageous embodiment of the invention, the blow-in opening is formed by a cylindrical bore that runs in the base portion and the shell. Here, the blow-in opening is formed by a single bore that runs in the cylindrical sleeve, such that in addition to the base portion, the lateral surface is also penetrated and the desired lateral opening is created, which can be manufactured in this way in a single pass.

In a further advantageous embodiment, the bore is inclined towards the longitudinal axis of the sleeve or the valve body. In addition to the effect of the lateral opening, the deflection of the gas jet can thus be optimized and enhanced by the inclined cylindrical bore. The cylindrical bore preferably has a circular cross-section and a length-to-diameter ratio (L/D) of 0.75 to 2.5.

In a further advantageous embodiment, the cylindrical bore has an oval or rectangular cross-section. Such a configuration can be advantageous for optimally distributing the gaseous fuel in a large or unusually shaped combustion chamber. Even in the event that the gas valve does not project precisely centrally into the combustion chamber, such shaping of the blow-in opening can be advantageous.

### BRIEF DESCRIPTION OF THE DRAWINGS

The drawing shows various examples of the gas valve according to the invention. The following is shown in the figures:

FIG. 1 a gas valve as is known in the prior art,

FIG. 2a a first exemplary embodiment of a gas valve according to the invention,

FIG. 2b a side plan view of the gas valve or the cylindrical sleeve shown in FIG. 2a and rotated 90 degrees, and

FIG. 3 a further exemplary embodiment illustrated in the same manner as FIG. 1.

### DETAILED DESCRIPTION

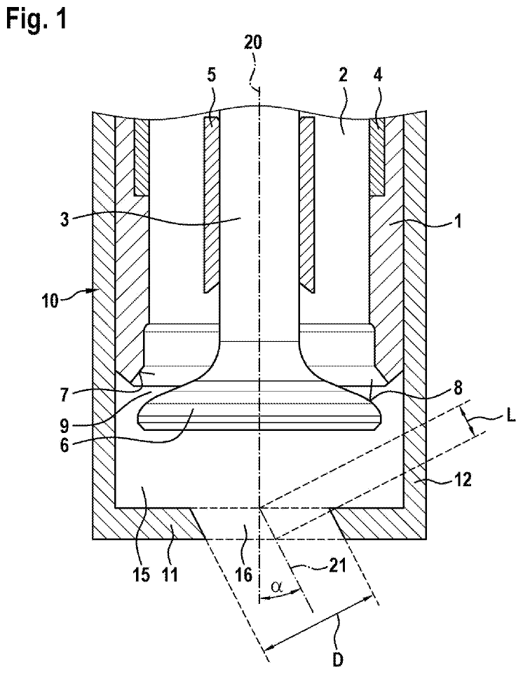

In FIG. 1, a gas valve is shown for blowing a gaseous fuel into a combustion chamber or also into an intake tract of an engine, as is known in the prior art, wherein only the essential portions of the gas valve are shown. The gas valve comprises a valve body 1 that is substantially cylindrical in shape and in which a gas space 2 is formed, which is fillable with gaseous fuel under a blow-in pressure. In the gas space 2, a rotationally symmetrical valve element 3 is arranged in a longitudinally slidable manner, which at its end comprises a plate-shaped end portion 6 that projects out of the valve body 1. A sealing surface 8 facing the valve body 1 is formed on the plate-shaped end portion 6, with which the valve element 3 cooperates with a valve seat 7 configured at the combustion chamber side, which is lower in the drawing, of the valve body 1, for opening and closing a flow cross-section 9, which is actuated open between the sealing surface 8 and the valve seat 7 when the valve element 3 is in its opening position, as shown in FIG. 1 To move the valve element 3 in the longitudinal direction, a plunge armature 5 is arranged on the valve element 3, which cooperates with an electromagnet 4 formed in the valve body 1, such that the valve element 3 is moved out of the valve body 1 in an opening direction when the electromagnet 6 is powered. This movement is carried out counter to the force of a closing spring (not shown in the drawing), which pushes the valve element 3 into a closed position with the electromagnet 4 switched off and abutting the valve seat 7.

The valve body 1 is surrounded by a cylindrical sleeve 10, which extends beyond the valve body 1 on the combustion chamber side. The cylindrical sleeve 10 has a base portion 11 and a lateral surface 12 adjacent to the base portion 11. A chamber 15 is delimited by the base portion 11, the lateral surface 12, and the plate-shaped end portion 6 of the valve element 3, into which the plate-shaped end portion is immersed in the opening position of the valve element 3 so that the gaseous fuel flows from the gas space 2 into the chamber 15. From the chamber 15, the fuel enters a combustion chamber (not shown in greater detail), or also an intake tract of an engine, via a blow-in opening 16. The blow-in opening 16 is formed as a cylindrical bore 18 in the base portion 11, wherein the axis 21 of the cylindrical bore 18 forms an angle a with the longitudinal axis of the valve body 1 in order to laterally deflect the gas jet exiting from the blow-in opening 16.

The ratio of length L of the bore 18 to its diameter (L/D ratio) is less than 1, which restricts the lateral deflection of the gas jet, because the steering effect is stronger the larger the L/D ratio, i.e. the longer the bore 18 is in relation to its diameter. The deflection caused by the bore slope is therefore low in this gas valve known from the prior art.

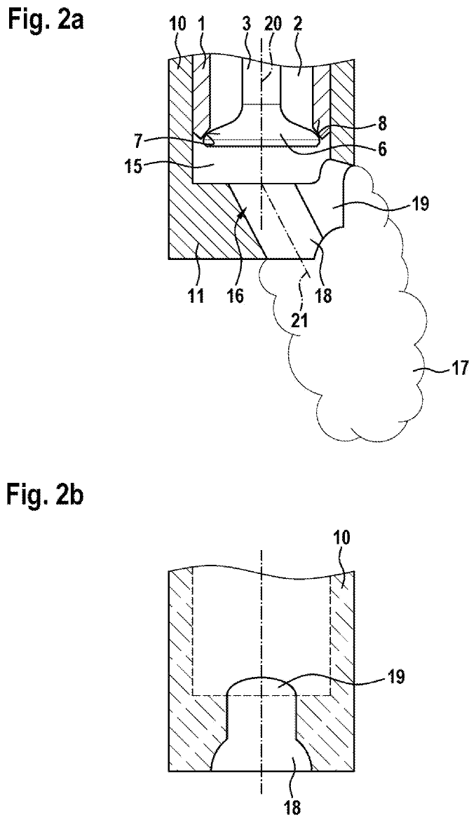

FIG. 2a shows a first exemplary embodiment of a gas valve according to the present invention, wherein the illustration substantially corresponds to that in FIG. 1. In the base portion 11, a cylindrical bore 18, and in the lateral surface 12, a lateral opening 19 is formed, which together form the blow-in opening 16 through which the gaseous fuel from the chamber 15 enters the combustion chamber. The lateral opening 19 in the lateral surface 12 enhances the deflection effect and causes a clear deflection of the gas jet 17 to the right, as illustrated in FIG. 2a. For clarity, FIG. 2b shows a side plan view of the gas valve or the cylindrical sleeve 10, wherein the view is rotated by 90° in relation to FIG. 2 a. The configuration of the lateral opening 19 can be independent of the cylindrical bore 18, which allows for great freedom in the design. Through a targeted optimization of the lateral opening 19, the effect can be optimally adjusted to the respective combustion chamber, e.g. in particularly large or unusually shaped combustion chambers.

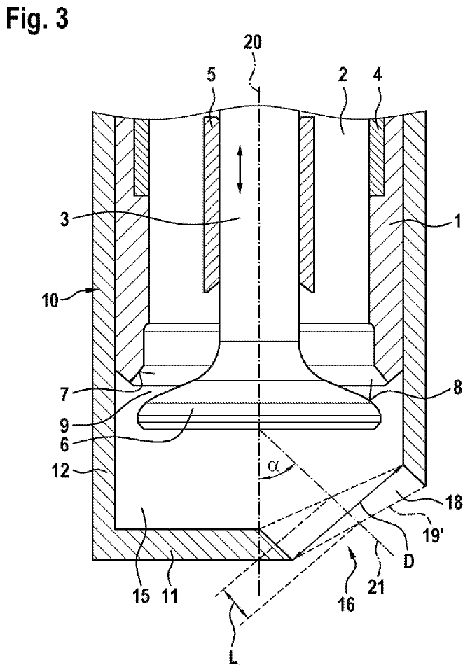

In FIG. 3, another exemplary embodiment of a gas valve according to the invention is shown in the same illustration, wherein only the differences from the exemplary embodiment shown in FIG. 2a are discussed in the following. The blow-in opening 16 is here formed in the shape of just a single cylindrical bore 18. The cylindrical bore 18 can thus be carried out by a single machining step by forming a bore having a correspondingly large diameter and at a tilt angle α in relation to the longitudinal axis 20, such that it extends both in the base portion 11 and also in the lateral surface 12 of the cylindrical sleeve 10. The blow-in opening 16 thus easily receives a lateral opening, which, as already explained above, significantly reinforces the lateral deflection of the leaking gas jet. Again, the L/D ratio can be relatively small in the range of 0.75 to 2.5, which is space-saving compared to a longer blow-in opening. The short design of the gas valve that is thus enabled reduces the risk of overheating at the end of the cylindrical sleeve 10 due to the combustion chamber gases.

The cylindrical bore 10 can have a circular cross-section as in the exemplary embodiments shown. However, it is also possible to form the cylindrical bore 10 having an oval or rectangular cross-section, which is another parameter for optimal distribution of the gaseous fuel in the combustion chamber. In the context of this invention, a cylindrical bore is a shape that results when a closed curve is moved along a straight path.

1. A gas valve for metered dispensing of a gaseous fuel, the gas valve having a valve body (1), in which a gas space (2) which can be filled with a gaseous fuel is formed, and a valve element (3) arranged to be movable longitudinally in the gas space (2), wherein the valve element (3) comprises a plate-shaped end portion (6), which cooperates with a valve seat (7) formed on the valve body (1) for opening and closing an annular flow area (9), and the gas valve having a cylindrical sleeve (10) surrounding the valve body (1), the cylindrical sleeve (10) including a base portion (11) forming an end of the sleeve (10) and a lateral surface (12) adjoining the base portion (11), wherein the base portion (11), the lateral surface (12), and the plate-shaped end portion (6) delimit a chamber (15), wherein chamber (15) comprises a blow-in opening (16), which is formed in the base portion (11) and in the lateral surface (12) of the cylindrical sleeve (10).

2. The gas valve according to claim 1, wherein the blow-in opening (16) is formed from a cylindrical bore (18) formed in the base portion (11) and a lateral opening (19) formed in the lateral surface (12).

3. The gas valve according to claim 1, wherein the blow-in opening is formed by a cylindrical bore (18) extending in the base portion (11) and in the lateral surface (12).

4. The gas valve according to claim 2, wherein a central axis (21) of the bore (18) is inclined by an angle α in relation to a longitudinal axis (20) of the valve body (1).

5. The gas valve according to claim 2, wherein the cylindrical bore (18) has a circular cross-section.

6. The gas valve according to claim 5, wherein a length (L) to diameter (D) ratio (L/D) of the cylindrical bore (18) is between 0.75 and 2.5.

7. The gas valve according to claim 2, wherein the cylindrical bore (18) has an oval or rectangular cross-section.

8. The gas valve according to claim 3, wherein a central axis (21) of the bore (18) is inclined by an angle α in relation to a longitudinal axis (20) of the valve body (1).

9. The gas valve according to claim 3, wherein the cylindrical bore (18) has a circular cross-section.

10. The gas valve according to claim 9, wherein a length (L) to diameter (D) ratio (L/D) of the cylindrical bore (18) is between 0.75 and 2.5.

11. The gas valve according to claim 3, wherein the cylindrical bore (18) has an oval or rectangular cross-section.
